(19) United States
(12) Patent Application Publication
(10) Pub. No.: US 2025/0304160 A1
(43) Pub. Date: Oct. 2, 2025

(54) CONTROL SYSTEM AND METHOD FOR VEHICLE STEERING

(71) Applicant: JAGUAR LAND ROVER LIMITED, Warwickshire (GB)

(72) Inventors: Bhavika Soni, Whitley, Coventry, Warwickshire (GB); William Ward, Whitley, Coventry, Warwickshire (GB); Samuel Tyrrell, Whitley, Coventry, Warwickshire (GB); Lee Adcock, Whitley, Coventry, Warwickshire (GB)

(21) Appl. No.: 18/864,106

(22) PCT Filed: May 5, 2023
(86) PCT No.: PCT/EP2023/061993

§ 371 Date: Nov. 8, 2024

(30) Foreign Application Priority Data
May 9, 2022 (GB) 2206752.4

(51) Int. Cl. B62D 7/15; B62D 6/02

(52) U.S. Cl. CPC B62D 7/159; B62D 6/02

(57) ABSTRACT

A control system for a vehicle is described. The control system comprises one or more controllers, the control system configured to receive a speed-dependent signal from a wheel speed sensor, the speed-dependent signal being dependent on a rate at which teeth of a toothed wheel move past the wheel speed sensor, and in dependence on the speed-dependent signal, permitting rear wheel steering of the vehicle. In this way, rear wheel steering can be permitted from a very low speed, at which speeds a vehicle or wheel speed signal is not generally available. By using a tooth count, such low speeds, or at least an indication that the vehicle is moving, may be estimated.

### TECHNICAL FIELD

The present disclosure relates to a control system and method for vehicle steering. Aspects of the invention relate to a control system, a method of controlling vehicle steering, a computer program and a vehicle.

### BACKGROUND

It is known to provide vehicles with rear wheel steering in addition to the usual front wheel steering. This may provide improved agility. When the vehicle is stationary it is undesirable for the rear wheels to be turned (steered), since the rear wheel steering system may not be rated for continuous use in this state.

It is an aim of the present invention to address one or more of the disadvantages associated with the prior art.

### SUMMARY OF THE INVENTION

Aspects and embodiments of the invention provide a control system, a method of controlling vehicle steering, a computer program and a vehicle, as claimed in the appended claims.

In one aspect, there is provided a control system for a vehicle, the control system comprising one or more controllers, the control system configured to:
receive a speed-dependent signal from a wheel speed sensor, the speed-dependent signal being dependent on a rate at which teeth of a toothed wheel move past the wheel speed sensor; and
in dependence on the speed-dependent signal, permitting rear wheel steering of the vehicle.

In this way, rear wheel steering can be permitted from a very low speed, at which speeds a vehicle or wheel speed signal is not generally available. By using a tooth count, such low speeds, or at least an indication that the vehicle is moving, may be estimated.

The one or more controllers may collectively comprise:

at least one electronic processor having an electrical input for receiving the speed-dependent signal; and
at least one memory device electrically coupled to the at least one electronic processor and having instructions stored therein;
and wherein the at least one electronic processor is configured to access the at least one memory device and execute the instructions thereon so as to permit rear wheel steering of the vehicle in dependence on the speed-dependent signal.

The speed-dependent signal may be a time-dependent waveform in which a respective feature is generated each time a tooth of the toothed wheel moves past the wheel speed sensor. The time-dependent waveform may for example be a sinusoidal, sawtooth or square waveform.

The controller may be configured to permit rear wheel steering in dependence on a plurality of successive features within the speed-dependent signal occurring within a predetermined time interval. Viewed differently, the controller may be configured to permit rear wheel steering in dependence on a second feature within the speed-dependent signal occurring within a predetermined time interval with respect to a first feature within the speed-dependent signal.

The respective features may be peaks or troughs of a repeating waveform.

The control system may be configured to estimate a speed of a road wheel or the vehicle based on the speed-dependent signal, and to permit rear wheel steering if the estimated speed is greater than a threshold value. The estimate computed in this way may be different to a speed calculation used for different purposes (for example by an anti-lock braking system (ABS) of the vehicle).

The estimation of speed may be carried out using fewer than ten features of the speed-dependent signal, preferably fewer than five features of the speed-dependent signal, and still more preferably only two features of the speed-dependent signal. In this way, a speed estimate (and thus a determination of whether to permit rear wheel steering) may be obtained very early, and at very low speeds.

The controller may be configured to generate a vehicle or road wheel speed signal from the speed-dependent signal, wherein, at least below a predetermined speed, a decision to permit the rear wheel steering of the vehicle is made in dependence on the speed-dependent signal and not the speed signal.

The controller may be configured to receive speed-dependent signals from a plurality of sensors, each sensor associated with a different road wheel of the vehicle, and wherein the controller permits rear wheel steering in dependence on the speed-dependent signals generated by each of the plurality of sensors. Preferably, the controller permits rear wheel steering only if the speed-dependent signals for all of the plurality of sensors are indicative of the respective road wheel being in motion.

The controller may be configured to permit rear wheel steering in dependence on the speed-dependent signal only in a subset of driving modes of the vehicle. In particular, in some vehicle modes rear wheel steering may be permitted from a very low speed, in some modes low speed rear steering is permitted from slightly higher speeds, and in some modes low speed rear steering is not permitted at all.

According to another aspect there is provided a vehicle comprising a rear wheel steering system, one or more wheel speed sensors associated with at least the rear wheels of the vehicle, and a control system according to any preceding claim.

The vehicle may comprise a front wheel steering system, wherein the control system is configured to permit steering via the front wheel steering system mode while not permitting steering via the rear wheel steering system based on the speed-dependent signal.

According to another aspect there is provided a control method for steering a vehicle, the method comprising:
receiving a speed-dependent signal from a wheel speed sensor, the speed-dependent signal being dependent on a rate at which teeth of a toothed wheel move past the wheel speed sensor; and
in dependence on the speed-dependent signal, permitting rear wheel steering of the vehicle.

In another aspect, there is provided computer software that, when executed, is arranged to perform a method according to the above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic representation of a vehicle having an anti-lock braking system (ABS), front and rear steering systems and a controller;

FIG. 2 shows a wheel speed sensor for use with the present technique;

FIG. 3 schematically illustrates the rear wheel steering control system and method; and

FIG. 4 shows a schematic flow diagram of the control method.

### DETAILED DESCRIPTION

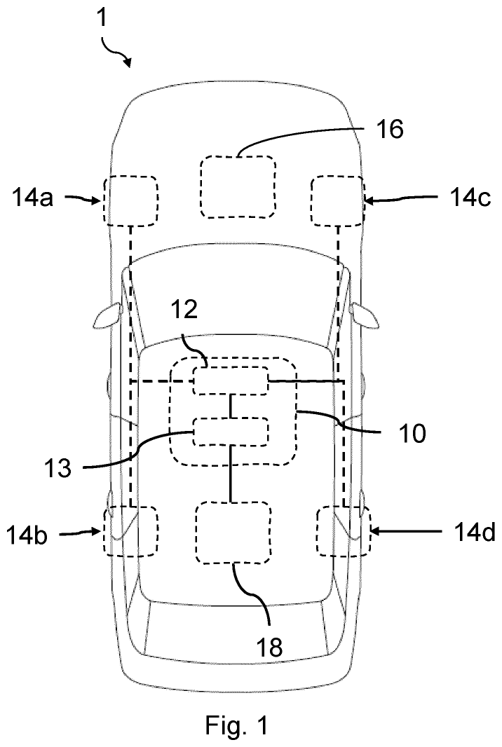

A vehicle 1 in accordance with an embodiment of the present invention is described herein with reference to the accompanying FIG. 1 The vehicle 1 comprises respective wheel speed sensors 14a-14d each associated with one of the road wheels (not shown) of the vehicle 1. The wheel speed sensors 14a-14d each output a speed-dependent signal to a control system 10, and in particular to an electronic stability program (ESP) 12 of the control system 10, which includes an anti-lock braking system (ABS) function and other functions relating to stability control of the vehicle. The control system 10 also comprises a rear wheel steering controller 13. In the present case, there are respective wheel speed sensors associated with all four wheels of the vehicle. The wheel speed sensors 14a-14d may be mounted at or proximate the road wheels (for example within a bearing unit of the wheel), or on an axle or drive shaft providing torque to the road wheels. The vehicle 1 also comprises a front wheel steering actuator 16 and a rear wheel steering actuator 18, which actuate the steering mechanisms to affect steering of the front and rear wheels respectively. The rear wheel steering actuator 18 is driven to actuate in dependence on the rear wheels of the vehicle 1 being in motion (not stationary), as determined using sensor data from the wheel speed sensors 14b, 14d associated with the rear wheels of the vehicle 1. The front wheel steering actuator 16 is driven to move independently of wheel speed, and in particular even if the vehicle is stationary and the wheels not rotating.

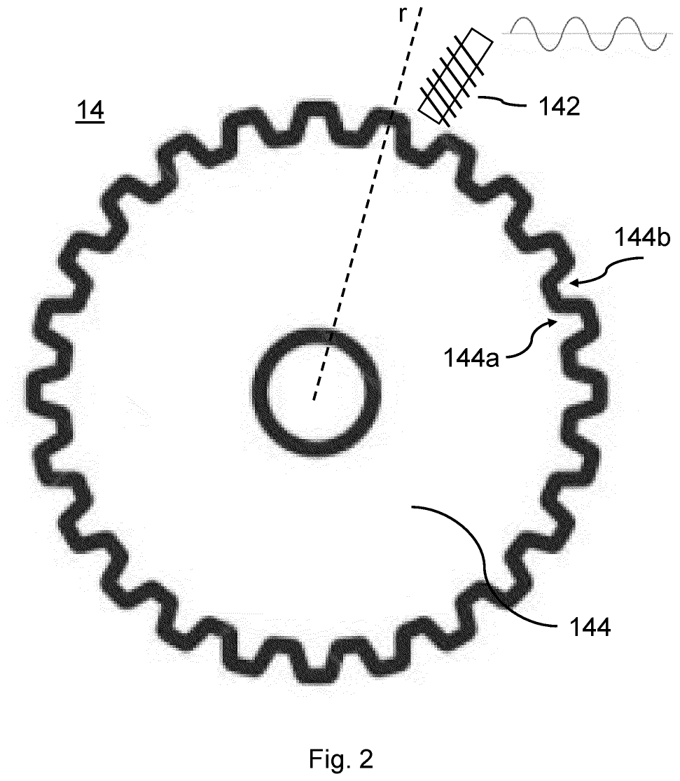

Several different forms of wheel speed sensors are available and could be used in the present method. These generally have two main parts: a wheel or ring which rotates with the road wheels (or with an axle or drive shaft driving the road wheels), and a fixed sensor mounted proximate the wheel or ring, which generates a signal as the wheel or ring moves past the sensor. The wheel or ring may be a ferromagnetic toothed wheel, or a ring of alternating magnetic poles. For the purposes of illustration FIG. 2 shows an example wheel speed sensor 14 using a fixed sensor 142 and a toothed wheel 144. The perimeter of the toothed wheel 144 can be seen to comprise teeth 144a and gaps 144b, which alternate around the perimeter of the toothed wheel 144. The fixed sensor 142 is disposed with respect to the toothed wheel 144 such that the alternating teeth 144a and gaps 144b pass through the magnetic field generated by the fixed sensor 142 as the toothed wheel 144 rotates. The fixed sensor 142 may comprise a wire coil wound around a magnetic core and permanent magnet. As the toothed wheel 144 rotates and the teeth and gaps alternately pass through the magnetic field, this results in an alternating voltage being induced in the wire coil, the frequency and amplitude of which is related to wheel speed. The output of the sensor is therefore an AC sinusoidal signal that changes frequency as the wheel speed changes.

In the alternative case of a ring of magnetic poles (not shown), the fixed sensor does not include a magnet, and instead the wheel itself comprises a series of magnets, disposed to have alternating poles at the periphery of the ring. The alternating magnetic poles around the circumference of the ring are analogous to the alternating teeth and gaps of the toothed wheel. As the ring of magnets rotates, the magnetic fields generated by the magnetic poles interact with the fixed sensor and induce a current in the wire coil of the fixed sensor, the frequency and amplitude of which is related to wheel speed. The output of the sensor is an AC square wave (approximate) signal that changes frequency as the wheel speed changes.

In some cases, the output of the sensor may also be indicative of the direction of rotation—for example due to the shapes of the waveform features being asymmetrical. This may be achieved for example by positioning the fixed sensor at an angle to the radius of the wheel, as shown in FIG. 2.

In the following description, the terminology “toothed wheel” will be used in the interests of brevity and clarity. However, it will be appreciated that the present technique is equally applicable to a ring of alternating magnetic poles as discussed above, or to any wheel speed sensor which outputs a speed-dependent signal.

The ESP 12 uses these time varying (e.g. AC) signals to compute various parameters, including a wheel speed, a tooth count (or in the case of a magnetic ring, a pole count), and (optionally) wheel direction of rotation. These are generated (separately) for each road wheel of the vehicle. At very low speeds (road wheel rotating slowly), the calculation of wheel speed is inaccurate. At least in some cases, EPS functions such as ABS do not calculate and/or output wheel speeds at all at very low speeds. Normally this is not a problem, since the main use of the wheel speeds is for ABS braking, which is relevant only at relatively high speeds.

The present technique is concerned with only permitting rear wheel steering when the (rear) wheels of the vehicle are in motion (turning/rotating). This is because the rear wheel steering system (actuator) may not be optimised to permit steering while the rear wheels are entirely stationary, in contrast with the front wheel steering system, which is required to permit steering even when the vehicle (and in particular the front wheels thereof) are stationary. Enforcing rear wheel steering on a stationary vehicle may cause scrub on the rear tyres as well as placing an undue load on the rear wheel steering actuator. It also avoids unnecessary battery load when rear wheel steering is not required.

Due to the fact that the wheel speed is only computed and/or output by the ESP 12 at speeds of (typically) 0.7 kph or greater, it is not possible to readily permit or deny rear wheel steering based on a wheel speed value computed by the ESP 12 at very low speeds. However, these low speeds are, or at least may be, suitable for permitting rear wheel steering. In some implementations the present technique does not require an accurate wheel speed, and instead requires only a relatively coarse indication that the wheels are moving (rotating). In such case, it has been recognised that other wheel motion dependent signals may be used to infer wheel motion, and thus form the basis of a decision to permit or deny rear wheel steering. The coarseness in this case means that the actual wheel speed need not be accurately known, but the indication should be reliable in the sense that it accurately indicates whether the wheels are moving or not moving. In other examples the actual speed may be more important, particularly in implementations in which a steering rate is dependent on the vehicle or wheel speed. In these implementations a relatively lower steering rate may be permitted at a relatively low speed, and a relatively higher steering rate may be permitted at a relatively high speed. Generally, a wheel speed computed by the ESP 12 is explicitly not used (at least when below a particular speed threshold, for example 0.7 kph, and potentially always) to determine whether to carry out rear wheel steering, and instead an alternative measure indicative of wheel motion is used, but still obtained (directly or indirectly) from the wheel speed sensors.

In one example, tooth count is used. The tooth count, which is an integer number, is generated (by the ESP) by detecting individual waveform peaks (and/or troughs, or other repeating features such as a rising or falling edge) in the signal generated by the wheel speed sensor and incrementing a counter each time such a peak and/or trough occurs. In other words, the tooth count is incremented each time a tooth and/or gap of the toothed wheel passes the fixed sensor. This number may periodically reset (or wrap back around to zero). The ESP uses the tooth count as part of the computation of the wheel speed, for example by measuring an increase in tooth count with respect to time. The wheel speed (expressed in terms of the linear ground speed of the wheel) can be readily computed based on the total number of teeth on the toothed wheel, the number of teeth counted in a predetermined interval, the length of the predetermined interval, and the diameter of the road wheel. For a wheel speed in terms of angular velocity (radians per second) the diameter of the road wheel is not required. In order to ensure an accurate measurement of wheel speed, a relatively large number of tooth counts per unit time are required. As indicated above, this means that a speed value computed at very low wheel speeds is deemed unreliable, due to very few increments of tooth count occurring within a given time frame, and is thus not generated and/or not output. However, the ESP does not only use the tooth count itself to generate the speed value, but is also able to output the tooth count directly (in this case to the controller 13). The present technique takes advantage of this to infer wheel motion based on the tooth count being incremented and/or on a rough speed estimate generated externally of (and downstream of) the ESP using a small number (and preferably only two) tooth count increments.

The present technique may use this tooth count signal (independently of its use to compute wheel speed) directly to either permit or deny rear wheel steering.

At its simplest, rear wheel steering may be permitted in dependence upon detecting any increase in the tooth count signal. For example, the controller may permit rear wheel steering subject to the tooth count having been incremented at least once in a predetermined time interval (for example in the preceding half second).

Alternatively, the controller may be configured to permit rear wheel steering in dependence on the tooth count being incremented a predetermined number (for example two or three) of times within a predetermined time interval (for example in the preceding half second). Equivalently, the rear wheel steering is permitted in this case in dependence on a predetermined number of successive features occurring within the speed-dependent signal within the predetermined time interval. This may be determined by determining that the tooth count has incremented (increased) by at least a certain (predetermined) number within the predetermined time period.

Use of only two successive features is preferable, since it permits a determination to be made at a lower speed, and the actual speed is relatively unimportant for the present purposes. In one implementation the tooth count signal is generated by and output from the ABS. However, in alternative implementations the controller may directly operate on the speed-dependent signal by detecting peaks or other features, rather than utilising a tooth count as an intermediate.

In the case of only two features being used, it will be understood that the controller may be configured to permit rear wheel steering in dependence on the tooth count being incremented a second time within a predetermined time interval with respect to the tooth count having been incremented a first time. Equivalently, the rear wheel steering is permitted in this case in dependence on a second feature within the speed-dependent signal occurring within a predetermined time interval with respect to a first feature within the speed-dependent signal. This may be determined by starting a timer upon the tooth count incrementing once, and if the tooth count increments again within the predetermined time interval then rear wheel steering is permitted.

While an absolute wheel speed is not required to determine whether or not to permit rear wheel steering, preferably the control system may be configured to estimate a speed of a road wheel or the vehicle based on the speed-dependent signal (using the tooth count), and to permit rear wheel steering if the estimated speed is greater than a threshold value, which may be set very low (for example 0.1 km/h). However, unlike the full computation carried out conventionally by the ESP system 12 (for example), the wheel speed estimate is carried out using a relatively small number of features of the speed-dependent signal (that is, a small number of increments of the tooth count), for example fewer than ten features, preferably fewer than five features of the speed-dependent signal, and still more preferably only two features of the speed-dependent signal. This results in a relatively inaccurate speed estimate, but it is generated very early from stationary (only two teeth need to pass the fixed sensor, corresponding to a very low proportion of a full rotation of the vehicle wheel), and can be generated for very low speeds.

Meanwhile, the ESP 12 is configured to generate a vehicle or road wheel speed signal from the speed-dependent signals of the wheel speed sensors 14a-14d, for conventional purposes, as mentioned above. However, at least below a predetermined speed (which could be the speed at which the ESP 12 starts to generate and/or output a speed value), a decision to permit the rear wheel steering of the vehicle 1 is made in dependence on the count signal (or equivalent raw signal indicative of wheel motion), and not using the computed speed of the vehicle or wheels output by the ESP.

The ESP 12 outputs wheel speed, tooth count and wheel direction of rotation for each of the wheels of the vehicle 1. Generally, the present technique uses only these values for each of the rear wheels of the vehicle. In order to permit rear wheel steering, it should be determined that all wheels of the vehicle are in motion. As a result, rear wheel steering will not be permitted if any of the rear wheels are stationary, which would give rise to excessive tire wear due to scrub, and to excessive peak load on the actuator performing the steering.

It is also possible to infer that a wheel is in motion based on the wheel direction signal being indicative of forwards or backwards rotation, rather than being indicative of a stationary state. As such, wheel direction, as output from the ESPABS, may be used instead of tooth count. However, the wheel direction signal does not provide any indication of actual rotational speed, and so in some cases it is possible that a determination based on wheel direction may not be appropriate in isolation.

Preferably, tooth count and wheel direction are used together, with wheel direction being used to confirm the determination based on tooth count. In other words, the controller may be configured to permit rear wheel steering only if the tooth count (or a derived speed estimate) satisfies a condition for each of the rear wheels, and only if the wheel direction indicated for each of the rear wheels is indicative of wheel motion.

In some implementations, the controller is configured to permit rear wheel steering in dependence on the speed-dependent signal only in a subset of driving modes of the vehicle. For example, rear wheel steering may not be permitted at all in an on-road “comfort” mode, while it may be permitted in off road modes, such as when driving on mud or sand, or in a rock crawl mode. In these modes rear wheel steering is permitted subject to the wheel motion requirement applied by the present technique. In principle other implementations may provide for driving modes in which rear wheel steering is provided and the wheel motion requirement waived.

It will be appreciated that the vehicle also comprises a front wheel steering system. The front wheel steering system does not have the same limitations as the rear wheel steering system, and in particular is rated to be operated while the front wheels are stationary. Accordingly, the control system is configured to permit steering via the front wheel steering system mode while not permitting steering via the rear wheel steering system based on the speed-dependent signal. It will be appreciated that separate controllers may be provided for the front and rear wheel steering.

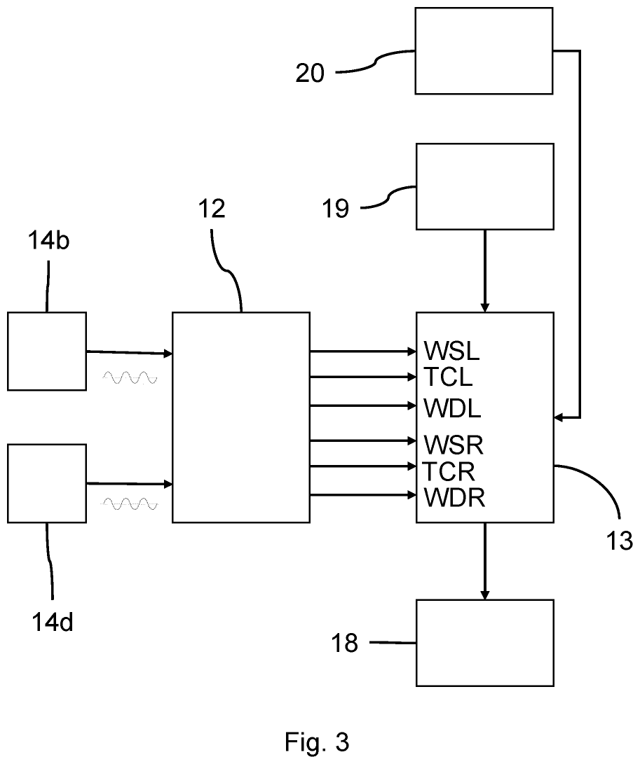

Referring to FIG. 3, a schematic block diagram is provided which sets out the vehicle components and signal flows involved in the present technique.

The wheel speed sensors 14b, 14d are shown, and output respective AC signals to the ESP 12 for each of the left and right rear wheels. The ESP 12 processes the received AC signals and generates, in respect of the left rear wheel, a tooth count TCL, wheel speed WSL and wheel direction WDL and in respect of the right rear wheel, a tooth count TCR, wheel speed WSR and wheel direction WDR. These are provided to the rear wheel steering controller 13. A driving mode selector 19 is provided, which is configured to select a driving mode for the vehicle 1. Different driving modes of the vehicle may have different characteristics, such as suspension stiffness, ABS usage, acceleration or braking profiles and the like. The selection of driving mode may be made by the driver manually, or automatically based on vehicle sensor data. The selected driving mode is provided to the rear wheel steering controller 13. A steering module 20 is also provided which generates a steering request based on either a manual driving input (via a steering wheel) or an automated driving input. The steering request is provided to the rear wheel steering controller 13. The rear wheel steering controller 13 is configured to determine from the selected driving mode whether rear wheel steering is available, determine from the tooth count signals TCL and TCR in respect of the left and right rear wheels and the wheel direction signals WDL and WDR in respect of the left and right rear wheels whether rear wheel steering is available, and if it is determined that rear wheel steering is available, the rear wheel steering controller issues a steering demand to a steering actuator 18 to adjust the orientation of the rear wheels based on the steering request from the steering module 20.

Generally, vehicle controller systems are of a modular nature, both structurally and functionally. It is to be understood that the or each controller within the control system of the present application can comprise a control unit or computational device having one or more electronic processors (e.g., a microprocessor, a microcontroller, an application specific integrated circuit (ASIC), etc.), and may comprise a single control unit or computational device, or alternatively different functions of the or each controller in the control system may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the controller to implement the control techniques described herein (including some or all of the functionality required for the method described herein). The set of instructions could be embedded in said one or more electronic processors of the controller; or alternatively, the set of instructions could be provided as software to be executed in the controller. A first controller or control unit may be implemented in software run on one or more processors. One or more other controllers or control units may be implemented in software run on one or more processors, optionally the same one or more processors as the first controller or control unit. Other arrangements are also useful.

Each of the controllers may comprise at least one electronic processor having one or more electrical input(s) for receiving one or more input signal (from one or more of the other controllers), and one or more electrical output(s) for outputting one or more output signal(s) (to one or more of the other controllers). The, or each, electronic processor may comprise any suitable electronic processor (e.g., a microprocessor, a microcontroller, an ASIC, etc.) that is configured to execute electronic instructions. The, or each, electronic memory device may comprise any suitable memory device and may store a variety of data, information, threshold value(s), lookup tables or other data structures, and/or instructions therein or thereon. In an embodiment, the memory device has information and instructions for software, firmware, programs, algorithms, scripts, applications, etc. stored therein or thereon that may govern all or part of the methodology described herein. The processor, or each, electronic processor may access the memory device and execute and/or use that or those instructions and information to carry out or perform some or all of the functionality and methodology described herein.

The at least one memory device may comprise a computer-readable storage medium (e.g. a non-transitory or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

The or each controller may comprise at least one electronic processor configured to execute electronic instructions stored within at least one memory device, which when executed causes the electronic processor(s) to carry out the method as hereinbefore described. A similar structure may be provided for each controller. However, it will be appreciated that embodiments of the present invention can be realised in any suitable form of hardware, software or a combination of hardware and software. For example, it is contemplated that the present invention is not limited to being implemented by way of programmable processing devices, and that at least some of, and in some embodiments all of, the functionality and or method steps of the present invention may equally be implemented by way of non-programmable hardware, such as by way of non-programmable ASIC, Boolean logic circuitry, etc.

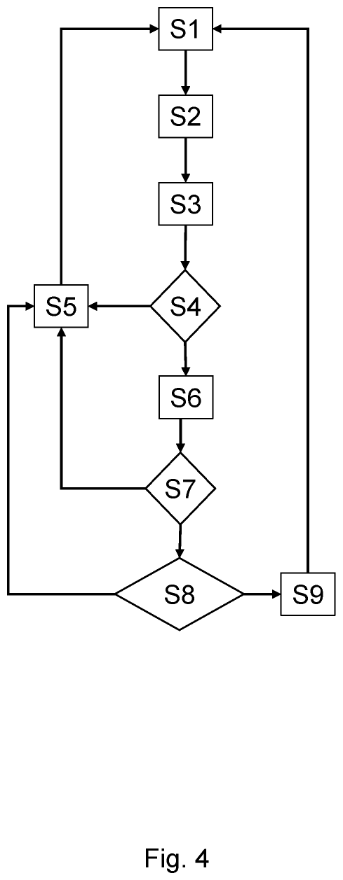

Referring to FIG. 4, a schematic flow diagram is provided illustrating one implementation of the method. At a step S1, speed-dependent signals are generated at each of the wheel speed sensors 14a-14d, and are provided to the ESP 12. At a step S2, the ESP 12 generates, in respect of each (rear) wheel, a tooth count, a wheel direction and a wheel speed, and provides these to the rear wheel steering controller 13. At a step S3, the driving mode selector provides to the rear wheel steering controller an indication of a current driving mode of the vehicle. At a step S4, the rear wheel steering controller determines whether rear wheel steering is permitted in dependence on the current driving mode. In some implementations the rear wheel steering controller further determines, in dependence on the current driving mode, whether rear wheel steering is permitted from a very low speed, or from a standard minimum speed. In the case that the current driving mode is determined to be one in which rear wheel steering is not permitted, then rear wheel steering is not permitted (denied) at a step S5, and the process returns to the step S1. In the case that the current driving mode is determined to be one in which rear wheel steering is permitted, then at a step S6 a wheel speed estimate is obtained for each wheel based on the tooth count. The wheel speed estimate for each wheel is then compared with a speed threshold at a step S7. Optionally, the speed threshold may be dependent on driving mode (see step S4 above). If the wheel speed estimates for one or both of the wheels do not exceed the speed threshold, then rear wheel steering is denied at the step S5. If the wheel speed estimates for both rear wheels exceed the speed threshold, then at a step S8 it is determined whether the wheel direction parameter for each rear wheel is indicative of movement (that is, indicates forward or reverse rotation). If not, then rear wheel steering is denied at the step S5. If the wheel direction parameters for both rear wheels are indicative of movement, then the process moves on to a step S9 in which rear wheel steering of the vehicle is permitted. The process then reverts to the step S1. In this way, rear wheel steering is permitted in cases where actuation is unlikely to cause issues with scrub or actuator loading (due to the wheels being in motion) and is denied in cases where actuation is likely to be problematic (due to the wheels not being in motion).

It will be appreciated that various changes and modifications can be made to the present invention without departing from the scope of the present application. For example, all of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A control system for a vehicle, the control system comprising one or more controllers, the control system configured to:
receive a speed-dependent signal from a wheel speed sensor, the speed-dependent signal being dependent on a rate at which teeth of a toothed wheel move past the wheel speed sensor; and
in dependence on the speed-dependent signal, permitting rear wheel steering of the vehicle.

2. The control system of claim 1, wherein the one or more controllers collectively comprise:
at least one electronic processor having an electrical input for receiving the speed-dependent signal; and
at least one memory device electrically coupled to the at least one electronic processor and having instructions stored therein;
and wherein the at least one electronic processor is configured to access the at least one memory device and execute the instructions thereon so as to permit rear wheel steering of the vehicle in dependence on the speed-dependent signal.

3. The control system according to claim 1, wherein the speed-dependent signal is a time-dependent waveform in which a respective feature is generated each time a tooth of the toothed wheel moves past the wheel speed sensor.

4. The control system according to claim 3, wherein the controller is configured to permit rear wheel steering in dependence on a plurality of successive features within the speed-dependent signal occurring within a predetermined time interval.

5. The control system according to claim 3, wherein the controller is configured to permit rear wheel steering in dependence on a second feature within the speed-dependent signal occurring within a predetermined time interval with respect to a first feature within the speed-dependent signal.

6. The control system according to claim 3, wherein the respective features are peaks or troughs of a repeating waveform.

7. The control system according to claim 1, wherein the control system is configured to estimate a speed of a road wheel or the vehicle based on the speed-dependent signal, and to permit rear wheel steering if the estimated speed is greater than a threshold value.

8. The control system according to claim 7, wherein the estimation of speed is carried out using fewer than ten features of the speed-dependent signal, preferably fewer than five features of the speed-dependent signal, and still more preferably only two features of the speed-dependent signal.

9. The control system according to claim 1, wherein the controller is configured to generate a vehicle or road wheel speed signal from the speed-dependent signal, and wherein, at least below a predetermined speed, a decision to permit the rear wheel steering of the vehicle is made in dependence on the speed-dependent signal and not the speed signal.

10. The control system according to claim 1, wherein the controller is configured to receive speed-dependent signals from a plurality of sensors, each sensor associated with a different road wheel of the vehicle, and wherein the controller permits rear wheel steering in dependence on the speed-dependent signals generated by each of the plurality of sensors.

11. The control system according to claim 10, wherein the controller permits rear wheel steering only if the speed-dependent signals for all of the plurality of sensors are indicative of the respective road wheel being in motion.

12. The control system according to claim 1, wherein the controller is configured to permit rear wheel steering in dependence on the speed-dependent signal only in a subset of driving modes of the vehicle.

13. A vehicle comprising a rear wheel steering system, one or more wheel speed sensors associated with at least the rear wheels of the vehicle, and a control system according to claim 1.

14. The vehicle according to claim 13, comprising a front wheel steering system, wherein the control system is configured to permit steering via the front wheel steering system mode while not permitting steering via the rear wheel steering system based on the speed-dependent signal.

15. A control method for steering a vehicle, the method comprising:
receiving a speed-dependent signal from a wheel speed sensor, the speed-dependent signal being dependent on a rate at which teeth of a toothed wheel move past the wheel speed sensor; and
in dependence on the speed-dependent signal, permitting rear wheel steering of the vehicle.

16. Computer software that, when executed, is arranged to perform a method according to claim 15.
